(19) United States
(12) Patent Application Publication
(10) Pub. No.: US 2013/0001422 A1
(43) Pub. Date: Jan. 3, 2013

(54) Apparatus And Method For Monitoring The Condition Of A Living Subject

(75) Inventors: Gary Dean LAVON, Liberty Township, OH (US); Courtney WASSON, Cincinnati, OH (US); Bryan Keith WAYE, Mason, OH (US); Uwe SCHOBER, Schlossborn (DE); Michael FRANKE, Darmstadt (DE); Stefan Hubert HOLLINGER, Kronberg im Taunus (DE); Nadia Patricia LAABS, Cincinnati, OH (US); Robert Joseph SCHICK, West Chester, OH (US)

(73) Assignee: The Procter & Gamble Company, Cincinnati, OH (US)

(21) Appl. No.: 13/535,401

(22) Filed: Jun. 28, 2012

Related U.S. Application Data
(60) Provisional application No. 61/502,433, filed on Jun. 29, 2011.

(51) Int. Cl. G01T 1/00; G01J 1/00

(52) U.S. Cl. 250/338.1; 250/393

(57) ABSTRACT

A method and apparatus for monitoring the condition of a living subject may be self-adjusting or adjustable to accommodate different end uses. Adjustments might be made, for example, based on characteristics of the subject to be monitored (such as species, age, health, etc.), environment (such as home or industrial setting, room size, room contents, spurious signals in the environment), and set-up conditions (such as distance between the apparatus and living subject, alignment of the apparatus with the subject, etc.).

### CROSS REFERENCE TO RELATED APPLICATION

This application claims the benefit of U.S. Provisional Application No. 61/502,433, filed Jun. 29, 2011, which is herein incorporated by reference in its entirety.

### FIELD OF THE INVENTION

This disclosure relates generally to an apparatus and method for monitoring the condition of a living subject. In some aspects, this disclosure relates to an apparatus for contactless monitoring of a living subject. In some aspects, this disclosure relates to a method for adjusting the configuration and/or function of an apparatus for monitoring the condition of a living subject.

### BACKGROUND OF THE INVENTION

Sensors for the measurement of environmental conditions are known. Recently, contactless sensors have been adapted to monitor physiological conditions of a human subject. Such monitors may, for example, generate energy waves, assess the reflection of or other changes in the energy waves, and draw inferences about physiology from the changes in the energy waves. For example, a monitor may sense changes in the distance of the monitor from a living subject by generating ultrasound waves and detecting changes in the ultrasound waves as they are reflected back to the monitor. Some monitors may use algorithms to infer, for example, respiratory rate, from a series of small, recurring, cyclic changes in the distance between the monitor and the subject (e.g., the rise and fall of a human's chest while breathing). Monitors have been described which can, through sensors and data manipulation, identify vibrations, movement, temperature changes, humidity changes, and the like, such that a significant range of information about a human subject can be obtained without direct contact with the subject. That is, many sensors do not require the subject to be connected to probes or wires in order to infer possibly detailed information about the subject. For example, contactless sensors may be able to accurately identify respiration rate; heart rate; movement (or lack thereof); temperature; size; etc.

Such sensors have largely been developed for institutional or industrial use. For example, contactless sensors have been adapted for use in hospitals and other medical settings (including sleep study centers or laboratories); nursing homes; and diagnostic settings. Contactless sensors have been described for use as security measures, as in warehouses, boats, automobiles, and large shipping containers, where the detection of vibrations or movement consistent with a heartbeat or breathing could indicate the presence of trespassers or malfeasors. In such settings, the contactless sensors would typically be professionally installed and maintained. For example, the contactless sensors could be positioned, oriented, and calibrated by a person with experience and/or specialized knowledge of the sensors. The contactless sensors may also be used in a particular setting which is unlikely to change significantly. For example, the distance between the monitor and a patient's bed in a hospital, or the distance between a security sensor and the entrance to a room or vehicle, could be established during initial installation and would be unlikely to vary significantly over time. Further, such contactless sensors are likely to be relevant to any individual subject only for a limited time, such as the duration of a hospital stay.

Recently, uses for contactless sensors have been identified outside of institutional or industrial settings. For example, it has been recognized that contactless sensors may be suitable for use as a baby monitor, or home security system.

There remains a need for an apparatus and method for monitoring the condition of a living subject in a non-institutional setting, e.g. a home setting. There remains a need for an apparatus and method for monitoring the condition of a living subject by a lay person.

### SUMMARY OF THE INVENTION

An apparatus for contactlessly monitoring the condition of a living subject may comprise an electromagnetic wave generator, the electromagnetic wave generator being capable of producing electromagnetic waves of varying power, amplitude, duty cycle, and frequency. The apparatus may comprise a processor adapted to detect changes in an electromagnetic wave generated by the electromagnetic wave generator over time. The apparatus may also comprise a measurement device adapted to determine a distance between the apparatus and a target. At least one of the power, amplitude, duty cycle, or frequency of the electromagnetic waves generated by the electromagnetic wave generator is modified based on the distance between the apparatus and the target.

An apparatus for contactlessly monitoring the condition of a living subject may comprise an electromagnetic wave generator, the electromagnetic wave generator being capable of producing electromagnetic waves of varying power, amplitude, frequency, duty cycle, or output direction, wherein the electromagnetic waves are directed at a target in a scan area. The apparatus may comprise an electromagnetic wave receiver, the electromagnetic wave receiver being capable of receiving electromagnetic waves generated by the electromagnetic wave generator. The apparatus may also comprise a processor adapted to detect changes in an electromagnetic wave received by the electromagnetic wave receiver over time. The output direction of the electromagnetic waves is modified based upon a change in an electromagnetic wave detected by the processor.

A method for adjusting an apparatus for monitoring the condition of a living subject may comprise the steps of: providing an apparatus, the apparatus comprising an electromagnetic wave generator capable of producing waves of varying power, frequency, or both; and a processor adapted to detect changes in a wave generated by the wave generator over time; measuring a distance and/or direction between the apparatus and a target; and adjusting at least one of the power or frequency of the waves produced by the wave generator based on the distance and/or direction between the apparatus and the target.

### BRIEF DESCRIPTION OF THE DRAWINGS

FIG. 1 is a block diagram of an exemplary radio frequency monitoring device.

FIG. 2 is a graph of a monitor operating in a continuous measurement mode.

FIG. 3 is a graph of a monitor operating in an intermittent measurement mode.

FIG. 4 is a graph of a monitor operating in a continuous interval mode.

FIG. 5 is a graph of a monitor operating in an intermittent interval mode.

FIG. 6 is a schematic illustration of an exemplary relationship between an apparatus for monitoring and a monitoring target.

FIG. 7A is a schematic illustration of an apparatus with a set-up indicator.

FIG. 7B is a schematic illustration of the apparatus of FIG. 3A in a different set-up condition.

FIG. 7C is a schematic illustration of the apparatus of FIGS. 3A and 3B in a different set-up configuration.

FIG. 8A is a schematic illustration of an apparatus for monitoring a living subject relative to an initial scan area.

FIG. 8B is a schematic illustration of the apparatus of FIG. 4A relative to an adjusted scan area.

FIG. 9 is a schematic illustration of an array of antennas emitting an electromagnetic wave that is perpendicular to the surface of the array of antennas.

FIG. 10 is a schematic illustration of an array of antennas with a phase shift between the antennas of the array and thereby emitting a wave at an angle that is not perpendicular to the surface of the array of antennas.

FIG. 11 is a schematic illustration of a circular apparatus having an array of antennas whereby each antenna emits an electromagnetic wave at a 90 degree angle from the surface of the apparatus.

FIG. 12 is a schematic illustration of the relationship between an apparatus having a base and a remote receiving station.

### DETAILED DESCRIPTION OF THE INVENTION

This disclosure relates generally to the use of contactless monitoring devices used to monitor a living subject, such as a person or a companion animal. A living subject may include an adult or a child. A child may include a person less than 1 years of age, less than 3 years of age, less than 5 years of age, less than 8 years of age, or less than 18 years of age. An adult may include a person 18 years of age or older. Such monitoring devices may be able to detect minute body movements associated with cardiopulmonary activity, respiration, heart rate, temperature, or other physiological conditions. Such monitoring devices may detect measurable phase change(s) in electromagnetic waves as they reflect off a living subject, and deduce from the phase change(s) information about cardiopulmonary activity or other physiological conditions. Information about the physiological condition of the subject, or changes in the physiological condition of the subject over time, may enable further inferences about more complex physiological processes or physical activities, such as sleep, brain function, exercise, metabolism, and the like. As used herein, a “contactless” monitor is one in which there is no physical object contacting the subject. For example, a contactless monitor does not require wires or physical probes attached to the subject, regardless of whether the wires or physical probes connect to some other equipment or not. As will be understood from the disclosure as a whole, bouncing energy waves off a subject or the subject's immediate surroundings is not physical contact with the subject, as used herein.

The contactless monitoring system is suitable for use in non-institutional setting, e.g. homes, hotel rooms, daycare centers when brought in by a child's parents (i.e. non-institutionally fixed into the daycare itself).

Contactless monitoring devices have been described using a variety of energy forms, including electromagnetic, sound, and light waves. As these monitors have developed, a parallel body of research has evolved regarding possible health risks associated with the proliferation of energy waves associated with wireless devices, including, but not limited to, cell phones, wireless computer networks, radio signals, power transmission lines, and the like. Some researchers have linked different forms or levels of energy wave exposure to potential health problems including cancers, non-cancerous tumors, autism spectrum disorder, cognitive impairment, memory deficit, EEG modifications, DNA damage, chromosome aberrations, micronucleus formation, fetal malformation, increased permeability of the blood-brain barrier, altered cellular calcium efflux and altered cell proliferation. For some energy forms at very high exposure levels, thermal effects alone may pose health risks. There is contradictory data available regarding the probability and magnitude of possible health effects associated with less extreme exposure levels.

Regardless of whether a causal relationship exists between exposure to radiation of the kind and power used in contactless monitors and health effects of concern, there is a growing segment of consumers who believe that a causal relationship exists. Thus, there is a two-fold benefit in addressing these concerns. First, if a causal relationship does exist, health effects from useful wireless devices may be reduced or avoided. Second, even if theories about a causal relationship are ultimately discredited, addressing potential health effects may make a wireless product more acceptable to consumers who are concerned about a causal relationship. As used herein, “health effects” or “possible health effects” refer to either or both of actual health effects (if any exist) and perceived health effects (without regard to whether or not the perceived health effects are an accurate, objective understanding of the situation).

An apparatus for monitoring the condition of a living subject may be an extremely sensitive motion detection system capable of detecting small body motions produced, for example, by respiratory and cardiac function. Motion detection may be achieved by transmitting an interrogating wave, for example, an electromagnetic field, at the target of interest, such as an infant or small child and then assessing the phase of a return signal(s) reflected back from the surface of the target. When the target surface is moving, as does the surface of the chest in conjunction with respiratory and cardiac activities, corresponding variations may be observed in the phase change of the return signal(s). An apparatus for monitoring the condition of a living subject may be useful, for example, as a sleep monitor. Respiratory or cardiac patterns and/or rates may be correlated to depth and/or duration of sleep. The depth of sleep and duration of various depths of sleep may be used to assess the overall sleep quality.

Motion-detection systems may use ultrasonic or optical techniques. However, an electromagnetically based approach may be preferred for monitoring small vibrations or motions. For example, with proper antenna design, an interrogating electromagnetic field may suffer minimal attenuation while propagating in air in comparison to ultrasonic signals, which propagate poorly in air. Thus, an electromagnetically based monitor can be used in a completely non-contacting mode and can, in some circumstances, be placed an appreciable distance, such as 5 to 10 feet or more, from the test subject if required. Electromagnetic signals in the microwave band, e.g. those having wavelengths ranging from 0.1 to 100 cm (corresponding to frequencies ranging from 300 MHz to 300 GHz), preferably those having wavelengths ranging from 0.3 to 30 cm (corresponding to frequencies ranging from 1 GHz to 100 GHz) may be suitably used as they may penetrate through heavy clothing. In comparison, some optical techniques would have a difficult time accurately detecting motion through even thin clothing. An electromagnetic approach may be able to simultaneously interrogate the entire chest surface and/or provide information pertaining to respiratory or cardiac functions manifested as chest wall motions. Conversely, by modifying the electromagnetic antenna design, a localized region of the chest surface could be interrogated to obtain information about some specific aspect of respiratory or cardiac function. Frequency modulation may be used to increase the sensitivity of an electromagnetic system. Using frequency modulation may permit sensitive measurements even when the subject is not still. Such versatility might be difficult to achieve with other motion detection techniques. Electromagnetic signals may include wavelengths of 10⁻¹⁶ to 10⁸ meters, corresponding to frequencies of 10²⁴ Hz to nearly 0 Hz (zero Hz), respectively. Electromagnetic signals include microwaves (wavelengths from 0.3 to 30 cm, corresponding to frequencies from 100 to 1 GHz), x-rays (wavelengths from 10⁻⁸ to 10⁻¹¹ meters, corresponding to frequencies of 10¹⁶ to 10¹⁹ Hz, respectively), terahertz waves (wavelengths from 0.1 to 1.0 mm, corresponding to frequencies of 300 GHz to 3000 GHz), and infrared waves (wavelengths from 750 nanometers to 1.0 mm, or 0.75 to 1000 micrometers), which may be used individually or in combination with one another. As used herein, “Electromagnetic signal(s)” or simply “signal(s)” does not encompass sonar, ultrasound, or acoustic waves, or optical techniques based on light visible to the unaided human eye.

A contactless apparatus for monitoring the condition of a living subject using electromagnetic signals may comprise coherent, linear, frequency-modulated, continuous wave radar with refinements to optimize the detection of small body movements.

At the electromagnetic frequencies ranging from 3 to 10 GHz the surface of the body is highly reflective. In addition, the biological tissue at these frequencies exhibits minimal penetration of radiated electromagnetic energy. Therefore, a return signal from a radiated electromagnetic field incident on the body will primarily contain information associated with events occurring at the body surface. Although there are no specific operating frequency limitations, systems operating at frequencies of 3 GHz and 10 GHz have proven useful.

Motion of a target with an electromagnetically reflective surface may be detected by transmitting an interrogating signal at the target surface, and then measuring the motion related time delay of the return signal that reflects back from the target. The interrogating signal travels at the speed of light and the time delay experienced by the return signal is equal to the round-trip distance to the target surface, divided by the speed of light. Thus, the time delay of the return signal is proportional to the range or distance to the target surface. If the target is moving in a manner that varies the target range, variations in the measured time delay can be used as a measure of target motion.

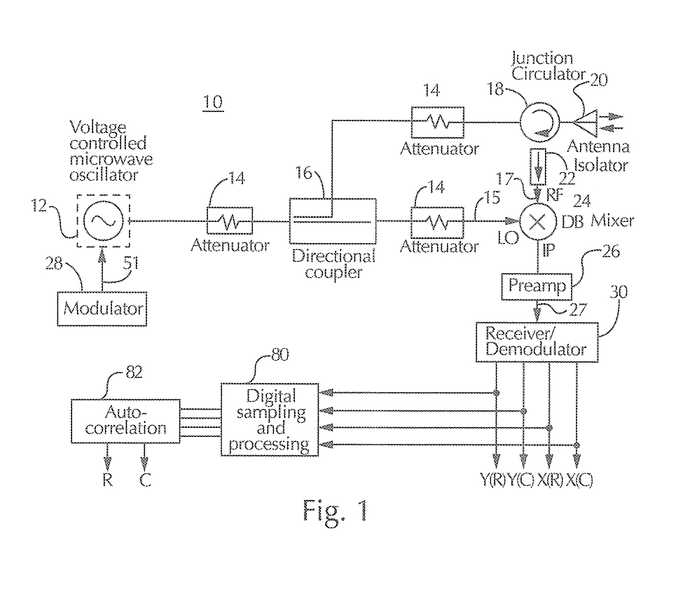

In one embodiment, an apparatus for monitoring the condition of a living subject monitor may include:
(1) a voltage controllable microwave oscillator 12 to produce a frequency modulated radio frequency RF signal,
(2) a directional coupler 16 to split the voltage controlled microwave oscillators output,
(3) fixed attenuators 14 to control the radiated power and local oscillator level 15,
(4) an antenna 20 for transmitting the interrogating field and receiving the target return signal,
(5) a circulator 18 to recover the return signal from the antenna 20, a double balanced mixer 24 for demodulating the RF return signal to obtain an intermediate frequency (IF) signal (the receiver/demodulator may perform another demodulation to retrieve the phase information from the IF signal);
(7) an isolator 22 to prevent local oscillator (LO) level 5 to RF 17 leakage through the double balanced mixer 24 from reaching the antenna 20; and
(8) a preamplifier 26 to minimize noise problems. In addition, a coaxial low-pass filter may be placed on the mixer IF in the 3 GHz system to block LO to IF leakage
   such as shown in FIG. 1. Other configurations of hardware components can be used to mix the transmitted and return signals to produce the IF result. Downstream processing may include, for example, receiver/demodulator 30, digital sampling and processing 80, and auto-correlation 82. Such an embodiment is described in greater detail in, for example, U.S. Pat. No. 4,958,638 to Sharpe et al.

The monitor apparatus 10 of FIG. 1 may include an electromagnetic wave generator 60, an electromagnetic wave receiver 62, and a processor 64. The electromagnetic wave generator 60 may include modulator 28, the voltage controlled microwave oscillator 12, the fixed attenuators 14, the directional coupler 16, and the antenna 20. The electromagnetic wave receiver 62 may include the antenna 20, the circulator 18, the double balanced mixer 24, the isolator 22, the preamplifier 26, and the receiver/demodulator 30. The processor 64 may include the digital sampling and processing 80 and the auto-correlation 82.

Typically, ranges of respiratory rates of normal, adult, human subjects correspond to frequencies of approximately 0.12-0.30 Hz (7-18 breaths per minute), while cardiac rate ranges correspond to approximately 0.8-1.5 Hz (48-90 beats per minute). Since there is more than an octave difference between the highest respiratory frequency and the lowest cardiac frequency, it is possible to examine the individual respiratory and cardiac components. In contrast, typical ranges of respiratory rates for infants and toddlers (e.g., humans 0-3 years of age) correspond to frequencies of approximately 0.4 Hz to 1.0 Hz (24 to 60 breaths per minute), while the cardiac rate ranges correspond to approximately 1.3 Hz and 2.7 Hz (80 to 160 beats per minute). Although the frequency ranges for cardiac and breathing rate are not a full octave apart over the full range for each, the high ends of both ranges are more than an octave apart, and the low ends of both ranges are more than an octave apart. Typical respiratory rate for a child 3-6 years of age is 20-30 breaths per minute; for a child 6-12 years of age is 18-26 breaths per minute; and for a child 12-17 years of age is from 12-29 breaths per minute. Typical cardiac rates for a child 1-10 years of age is 60-140 beats per minute; for a child 10 years of age to an adult is 60-100 beats per minute. It is possible, but uncommon, to have a fast breathing rate and slow pulse. Thus, it should be possible to distinguish cardiac and breath signals for most infants and toddlers with one measurement without interference by sorting the return signal by frequency.

Accordingly, it may be desirable to set up a monitor for either an adult or a young child, but not both, as different signal frequencies may be desirable to obtain the most sensitive measurements of cardiac and/or respiratory activity. For example, resolution of small, cyclic movements may benefit from the use of a signal frequency approximately two times, or three times, or more, greater than the frequency of the movement to be monitored. Use of significantly greater signal frequencies reduces the likelihood that repeated measurements will be taken at the same point in the cycle to be measured, creating the false impression that the movement to be monitored has ceased, or will be taken at points that create a false impression of the magnitude of the cycle of the movement to be monitored. Thus, if measuring respiration, for example, using a significantly greater signal frequency may prevent a false alarm indicating that respiration has stopped. In other words, significantly greater signal frequencies may provide more representative data, and, in turn, may be used to draw more accurate inferences. This improvement in accuracy may be desirable particularly, but not exclusively, when the physiological condition inferred from the return signal is itself used to make further inferences, for example, when respiratory and/or cardiac rate is used to infer the depth and/or duration of sleep. It is to be appreciated that the monitor apparatus may detect the cardiac or respiratory function of more than one living subject if there is more than one living subject in the scan area.

In order to reduce health effects for the subject being measured, minimizing the exposure to sources of electromagnetic radiation is desired. This may be particularly true when infants or other young subjects (e.g., puppies, kittens, or other juvenile companion animals) may be exposed to the electromagnetic radiation, either directly, as the subject to be measured, or indirectly, as by proximity to the subject to be measured. One health effects hypothesis is that electromagnetic radiation may have a greater effect, at lower doses, on infants or other young subjects than on adults because of the rapid growth and unsettled patterns of biological activity in immature animals. A reduction in exposure to electromagnetic radiation can be achieved by modifying the signal power to which the subject is exposed and/or the distance from the source to control the power flux at the subject. The intensity of linear waves radiating from a point source (energy per unit of area perpendicular to the source) is inversely proportional to the square of the distance from the source; so an object (of the same size) twice as far away, receives only one-quarter the energy (in the same time period).

Alternatively, electromagnetic radiation exposure can be reduced by conducting measurements intermittently (versus continuously), and/or alternating wave types. As used herein, “continuous measurement” refers to the continuous propagation of energy waves for the purpose of sensing the environment around the monitor. In contrast, “intermittent measurement”, refers to periodic propagation of electromagnetic waves for the purpose of sensing the environment around the monitor with intervening periods of inactivity. A monitor may be in “continuous use”, that is, turned on and collecting data, in an “intermittent measurement” mode. For example, a monitor may be turned on and collecting data all day and all night, without interruption, for a period of days, weeks, months, or even years, but taking measurements only intermittently through that period of continuous use.

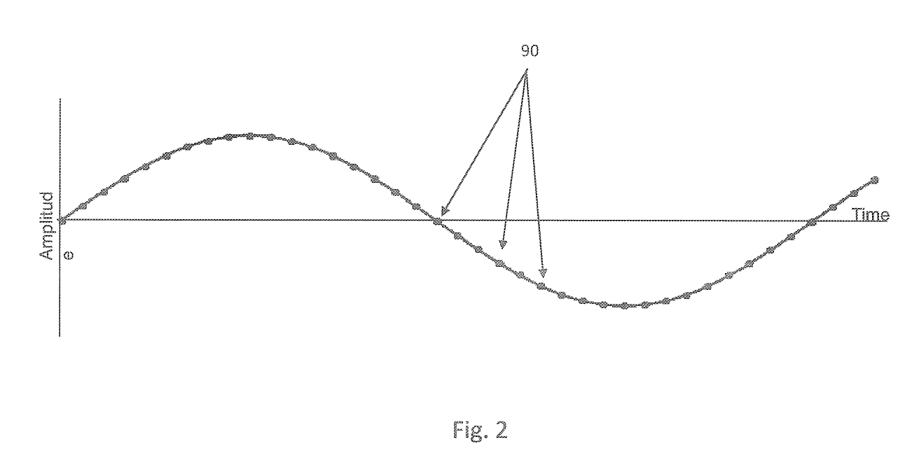

FIG. 2 shows a graph of a monitor apparatus operating in a continuous measurement modes. In a continuous measurement mode, the monitor apparatus may continuously collect measurements 90. It is to be appreciated that a monitor apparatus continuously conducting measurements has a duty cycle of 100%. As used herein, “duty cycle” refers to the amount of time that the monitor spends taking measurements as a fraction of the total time the monitor is in use.

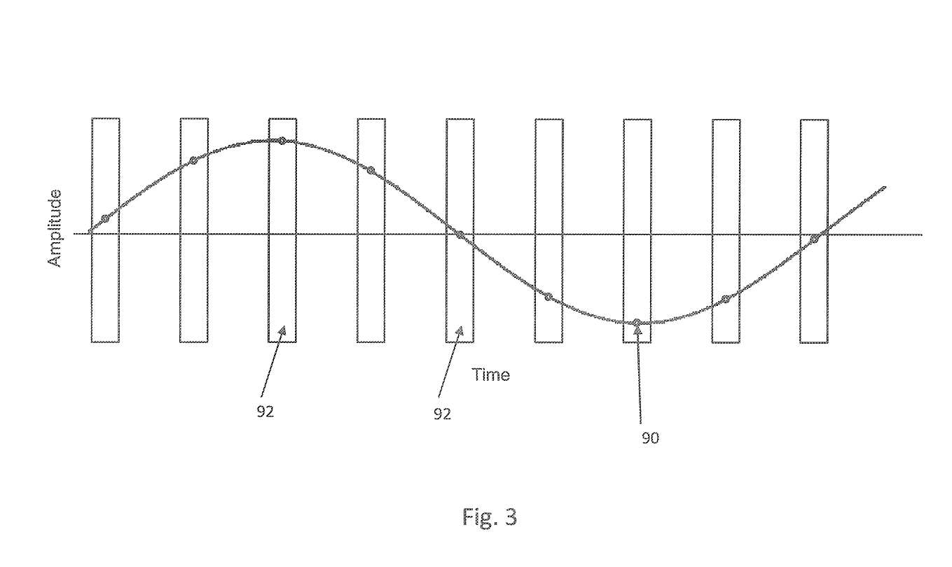

For a reduction of the electromagnetic radiation exposure without losses in sensitivity and range, a monitor apparatus may operate in intermittent measurement mode with frequencies higher than the frequency of the signal to be measured such as shown in FIG. 3. The monitor of FIG. 3 has a reduced duty cycle of 33%. The monitor apparatus may intermittently collect measurements 90 by emitting a series of electromagnetic wave pulses 92 at the target. It is to be appreciated that the monitor may be configured to conduct intermittent measurements resulting in a duty cycle as low as 1% as long as the return signal is strong enough to collect measurements 90. It is to be appreciated that a duty cycle of 1% results in a reduction of the emitted energy of 99%. The duty cycle may be adapted to the quality of the return signal. The duration of a pulse may be as short as 1 microsecond. In at least one exemplary configuration, 100 pulses may be sampled per second.

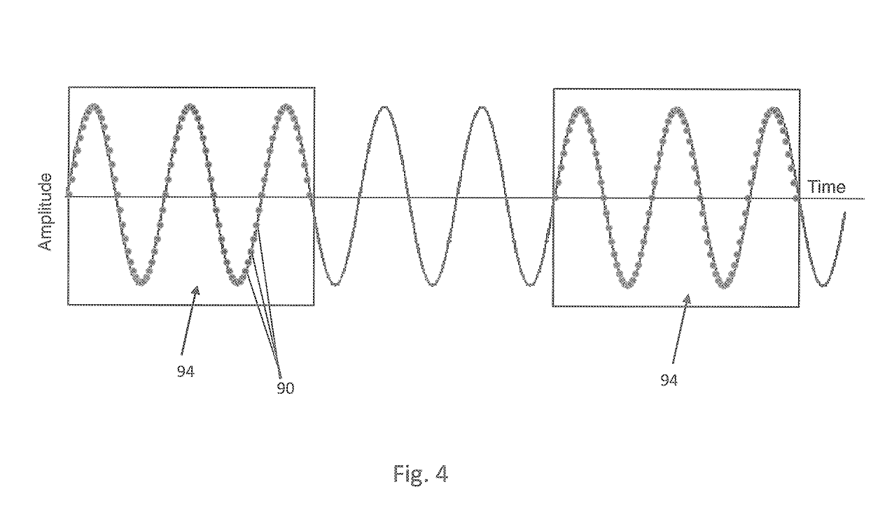

In order to reduce exposure to electromagnetic radiation, in some exemplary configurations, the monitor apparatus may operate in a continuous interval mode such as shown in the graph of FIG. 4. Continuous interval mode includes periods of continuous measurements 94 followed by periods of inactivity. In the example shown in FIG. 4, the monitor operates at a reduced duty cycle of 50%. It is to be appreciated that the measurement time may cover a minimum number of pulses to detect the amplitude and the frequency of the input signal. The interval between the measurement pulses could be shorter, equal to or longer as the pulse itself and depends on the change rate of the signal to be measured.

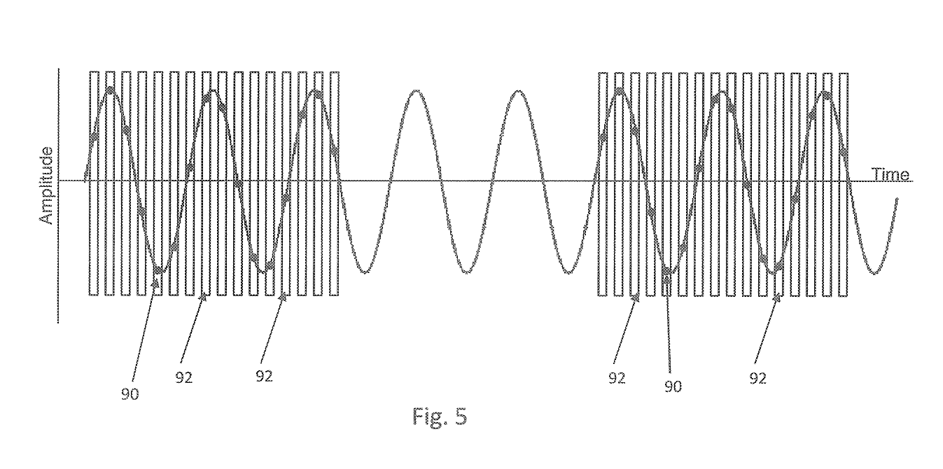

In yet other exemplary configuration, the monitor apparatus may operate in an intermittent interval mode such as shown in the graph of FIG. 5. Intermittent interval mode includes periods of intermittent measurements followed by periods of inactivity. In the example of FIG. 5, the monitor operates at a reduced duty cycle of 25%. It is to be appreciated that the monitor apparatus may be configured to operate in intermittent interval mode resulting in a duty cycle as low as 1% as long as the return signal is strong enough to collect measurements 90 similar to the intermittent mode shown in FIG. 3.

It is to be appreciated that the sampling rate, duty cycle, and timing of the pulses may be adapted to the frequency, change rate, required resolution and/or accuracy of the input signal when the monitor is configured to operate in intermittent mode, continuous interval mode, or intermittent interval mode.

The conditions of use for contactless monitors in institutional settings may be fairly well controlled. For example, contactless monitors may be professionally installed and calibrated for use in a specific environment. In contrast, the conditions of use for contactless monitors for home or consumer use may be more variable. For example, some consumers may misunderstand or disregard the instructions provided with a contactless monitor. As another example, home environments may vary significantly in terms of characteristics such as room size, room configuration (i.e., shape of room, protruding walls forming nooks, etc.), or furniture or other room contents. A portable, contactless monitor may be used in different environments, at different times, perhaps by different operators. Even a consumer who attempts to follow instructions regarding the positioning of a contactless monitor, such as distance from the subject to be monitored, may have to improvise based on the specific physical environment in which the monitor is used. Thus, a monitor designed for operation under certain conditions may result in more radiation exposure than the manufacturer intended because of variation in actual-use conditions. Further, to account for environmental variation, a contactless monitor may be pre-set to a relatively high power setting. That is, uncertain which specific environmental conditions may apply to the use of a contactless monitor for home and/or consumer use, a manufacturer may err on the side of higher power settings to ensure that return signals have adequate power to be reliably detected and assessed under worst-case conditions. Thus, in some environments, the power setting of a contactless monitor may be significantly higher than is necessary to achieve the desired benefits of the monitor. The desired benefits, of course, may vary with the type of monitor used and the type of hardware, firmware, software and the like used to log, display, manipulate and/or interpret the data created by the monitor.

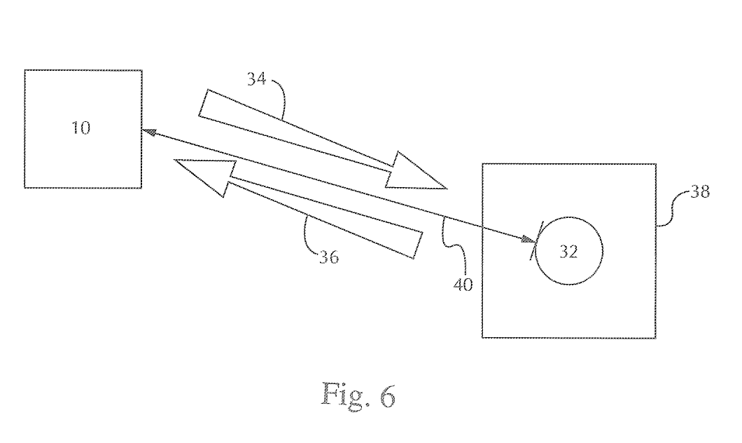

FIG. 6 is a schematic view of an exemplary monitor environment. Monitor apparatus 10 may generate outgoing or interrogating signals 34. The power of outgoing signals 34 is schematically shown as diminishing over linear distance. Similarly, return signals 36, reflected off of target 32 in scan area 38, also diminish over linear distance. These schematic representations are not to scale. Scan area 38 represents the footprint of the space from which the monitor apparatus 10 can detect reflective signals. Accordingly, return signals 36 reflect not only target 32, but also other objects within scan area 38. In addition, the signal may be dampened to some degree depending on the reflectivity of the target.

An monitor apparatus 10 for monitoring the condition of a living subject may comprise a range finder that is adapted to determine the distance 40 to the target 32 and/or desired scan area 38 and thereby result in an adjustment of one or more of the frequency, amplitude, wave length or power flux density at the target, transmitter power, etc., generated by the monitor apparatus 10. The range finder may comprise a laser based distance measure or may comprise a target, (e.g., a radio frequency identification (RFID) tag) that can be affixed in or near the monitoring area to aid in determination of the distance 40 and/or to focus the outgoing signals 34 of the monitor. In some embodiments, the monitor apparatus 10 includes an input station for manually entering inputs such as the distance 40 to the target 32. For example, a user may measure the distance 40 to the target 32 and input the distance into the monitor. The data input may be discontinuous or continuous. For example, discontinuous distance information may be input by a switch for “room size” or similar description, with two or more settings, as for large and small rooms, or near or far distances, or a range, such as 3-5 feet, 6-8 feet, 9-11 feet, 7-10 feet, and the like. Continuous distance information, for example, may be input as a specific measurement, such as 5.3 feet, or 7 feet, 2 inches. In some exemplary configurations, a plurality of RFID tags may be used to determine boundaries of the scan area 38.

The input station may comprise one or more of a variety of interfaces, such as dials, switches, keypads, arrow keys, keyboard touch screens, numeric key touch screens, touch pads, joysticks, roller balls. The input station may, for example, receive data from a wireless LAN, a mobile phone, a Smartphone, a mobile computer (such as a laptop or tablet computer), a wired internet or Ethernet connection, or by wireless data communication, or the like. Wireless data communication may include optical communication (e.g., based visible or infrared light), sound communication (e.g., ultrasonic remote control), electromagnetic communication such as radio frequency (e.g., near field communication (NFC) devices such as RFID tags; bluetooth; wireless location area network (WLAN) communications; and global system for mobile communication (GSM) communication; mobile phones). The input station may utilize voice recognition software, sounds, and optical signs. The input station may provide two or more interfaces, so that different users may use different interface(s) based on user preference. The input station may be used to input various measurements, including, for example, distance, power, frequency, age, weight, and the like.

The distance 40 between the monitor apparatus 10 and the target 32 may be reassessed periodically. For example, the distance measurement may be discarded and reacquired, or a request made to verify the distance measurement previously entered, when the apparatus is first turned on, when the apparatus loses power (as might happen, for example, if the apparatus is moved), or if the power of the return signals received by the apparatus are inconsistent with the expected power of the return signals based on the distance information previously available. If the distance is acquired automatically, variations in how “the measurement” is taken are possible. For example, the distance measurement may be an average over time, or a rolling average, or a measurement taken at a discrete point in time, such as at set-up or on request (e.g., the user may be able to arbitrarily trigger a new distance measurement). The distance measurement may be discarded and reacquired if one or more distance data points (e.g., one of several periodic measurements) is significantly different than one or more other recent data points. In some embodiments, the monitor apparatus 10 may not generate energy waves until a distance is determined, or may discontinue generating energy waves if the distance is uncertain (e.g., if inconsistent data is available, or in the event of power loss), or may reduce the power of the energy waves generated if the distance is uncertain.

In some embodiments, the monitor apparatus 10 may measure the power of the return signals 36 instead of, or in addition to, the distance to the target. If return signal strength is sufficient for measurement, the power of the outgoing signals 34 can be held constant. If return signal strength is insufficient for measurement, the power of the outgoing signals 34 can be increased. If return signal strength is stronger than is necessary for measurement, the power of the outgoing signals 34 can be decreased. In this manner, the power of the signals transmitted to the target is as low as reasonably possible to achieve the desired benefit. In some embodiments, the power of the outgoing signals 34 may be capped at a maximum safety threshold. In some embodiments, signal strength and distance 40 may both be measured. Such embodiments may determine the maximum safety threshold for the power of outgoing signals based at least in part on the distance to target. If return signal strength is insufficient, for example, because of intervening materials or spurious (e.g., non-system) signals of a competing frequency, the monitor apparatus 10 might not increase power to compensate for low signal return beyond the distance-based maximum safety threshold.

Monitor apparatus 10 may comprise a storage medium. The storage medium may be integral with, or separate from, the monitor apparatus 10. The storage medium may be configured to store various inputs (e.g., measurement data), return signal data, scan area and target data, and the like. The storage medium may be configured to remotely store data through a wireless internet connection.

Monitor apparatus 10 may comprise an optical sensor. The optical sensor may be a video camera. In some embodiments, video camera may provide monitor apparatus 10 with visual monitoring capability. Visual monitoring capability may be helpful, for example, if a caretaker or parent wishes to check on the subject to be monitored remotely. As a more specific example, if monitor apparatus 10 comprises an alarm or alarms related to changes in a monitored condition, visual monitoring capability may provide a caretaker or parent a quick way to ascertain the accuracy of the alarm and/or the severity of the situation. Visual monitors are well known in the art, including systems with remote viewing capability, closed circuit systems, “web cams”, portable viewers, and the like. In some embodiments, the optical sensor may be aligned so that the field of view for visual monitoring is co-extensive or substantially co-extensive with scan area 38. In such embodiments, it is possible to see if scan area 38 encompasses the desired monitoring area. In some embodiments, the field of view for visual monitoring may be larger than an overlap scan area 38. In such embodiments, the device(s) used for viewing visual images from monitor apparatus 10 may indicate the extent of scan area 38. For example, a viewing device may display the boundaries of scan area 38. As a more specific example, a viewing screen may have a permanent line within the perimeter of the screen to correspond to the boundaries of scan area 38, or viewing screen may electronically display the boundaries of scan area 38. In such embodiments, the viewing device may be useful in determining whether alarms or data outages (e.g., failure to detect a heartbeat or breathing) are due to lack of heartbeat or respiration (e.g., cardiac or respiratory arrest), or more benign circumstances, such as movement of target 32 outside of scan area 38.

It is to be appreciated that the optical sensor may detect the subject in the scan area 38 using a variety of techniques, including, for example, facial recognition, thermal changes and or video motion detection. Facial recognition techniques may compare facial features or selected portions of facial features of the subject with facial features stored in a database. Some facial recognition techniques may identify faces by extracting features or selected portions of facial features from an image of the subject's face. An algorithm may analyze the relative position, size, and/or shape of particular facial features such as, for example, eyes, nose, cheekbones, and jaw and then compare the facial features with images saved in the database. In some exemplary configurations, three-dimensional facial recognition techniques may be used. It is to be appreciated that three-dimensional facial recognition techniques may be used to identify a face of a subject from a range of viewing angles. Facial recognition techniques may be accomplished in a variety of ways. For example, a geometric technique may be used that analyzes distinguishing facial features. Or, a photometric technique may be used that uses statistically analysis to distill an image into values in order to compare the values with templates to eliminate variances.

Monitor apparatus 10 may be configured to measure environmental parameters such as, for example, light level, noise, temperature, scent, and the like that may have an effect on circadian rhythm. Various devices may be used with monitor apparatus 10 to measure light levels, noise, temperature, and scent.

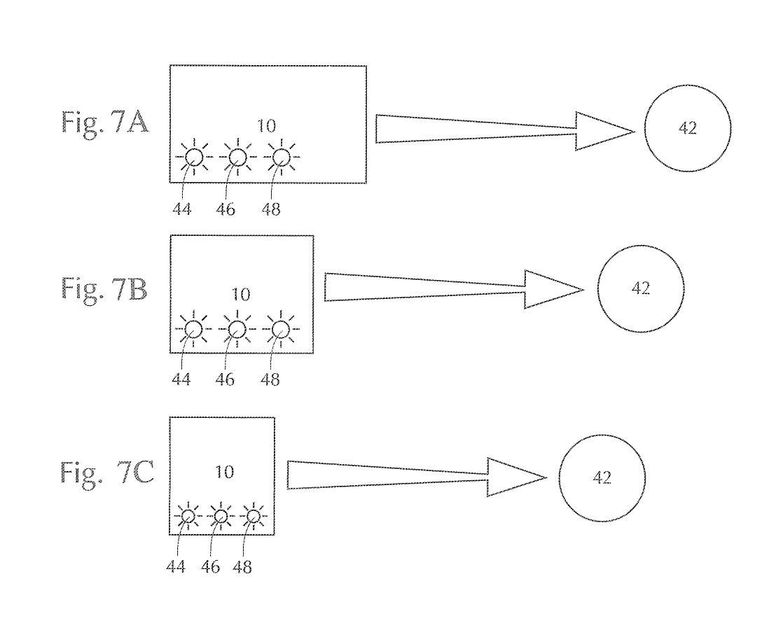

Monitor apparatus 10 may be used with optional set-up target(s) 42 to help focus the measurement wave toward the desired scan area 38 or target 32. A set-up target 42 may, for example, comprise an RFID tag, or a material highly reflective in the frequency of the electromagnetic waves used. In some embodiments, the set-up target(s) 42 is/are configured to mimic the signal expected from a subject to be monitored. In such embodiments, the set-up target(s) 42 can be used both to focus the outgoing signals 34 and to adjust the power and/or frequency of the outgoing signals 34. The monitor apparatus 10 and/or target(s) 42 may provide feedback, such as visible, audible, or tactile signals, to indicate when the monitor is properly positioned and oriented with regard to the desired scan area. For example, the apparatus and/or target(s) 42 may display lights, make noises, vibrate, or provide other feedback when the monitor apparatus 10 is properly set-up. In some embodiments, the monitor apparatus 10 and/or target(s) 42 may provide different feedback as set-up progresses. For example, monitor apparatus 10 and/or target(s) 42 may comprise a plurality of indicators that indicate proper alignment, for example, a series of lights, red, yellow and green, wherein misalignment would be indicated with red, near alignment yellow, and proper alignment green. As shown in FIGS. 7A, 7B, and 7C, monitor apparatus 10 may comprise a series of lights, 44, 46, and 48, which light up sequentially as the alignment and/or distance between monitor apparatus 10 and target(s) 42 improves. As other examples, the speed of a flashing light, the volume of a noise, the nature of a noise, the strength of a vibration, or a combination of any of the signals described above may be used to indicate successful set-up. Specific, non-limiting examples of noise feedback include the use of static or an unpleasant noise which may become more recognizable or more pleasant as alignment improves, or a series of beeps or notes which may converge to a single tone or harmonize as alignment improves.

The initial setup of the monitor apparatus in a nursery may include an assessment of the crib or bed where the subject sleeps. The device emits an outgoing electromagnetic wave that is reflected off of the crib or bed and received and analyzed to provide a baseline for comparison to subsequent return signals, e.g. when a subject is present. The device can use the baseline information to determine, for example, when the subject has been placed in the crib, when the subject has been removed from the crib, when the crib itself has been moved, horizontally or the mattress has been moved vertically, or other objects have been inserted into the crib.

A light source may be used for the initial setup of the monitor with respect to proximity and orientation of the target area. A light source such as a laser projection, for example, may emanate from the device. In other exemplary configurations, high intensity LED light sources may be used to illuminate the target area. The area covered by the light indicates the area in which the subject can be placed to achieve reflection of the interrogating signal in a way that allows the receiver to receive the return signal.

In an exemplary configuration where the monitor has video camera, the initial setup of the apparatus with respect to proximity and orientation of the target area can be accomplished through the use of a box, rectangle, or other shape on the video end of the monitor. The area covered by the box, rectangle, or other shape indicates the area in which the subject can be placed to achieve reflection of the interrogating signal in a way that allows the receiver to receive the return signal.

In some embodiments, the monitor apparatus 10 may be used to emit directional electromagnetic waves. It is to be appreciated that emitting directional electronic waves may reduce exposure to electromagnetic radiation compared with a monitor apparatus 10 emitting spherical electromagnetic waves. However, with the monitor apparatus 10 emitting directional electromagnetic waves, the scan area 38 may cover only a portion of the crib or bed of the subject. In such embodiments, movement of the subject being measured can result in the subject being outside the scan area 38 established when the apparatus was set up. For example, if the monitor apparatus 10 is used to assess the condition of a sleeping infant in a crib or bed, the scan area 38 may not encompass the entire crib or bed. Thus, if the infant moves within the bed but outside the scan area 38, the monitor apparatus 10 may be unable to detect the infant. The monitor apparatus 10 would therefore not provide the desired data related to the condition of the infant, and, if the monitor apparatus 10 is equipped with an alarm, the infant's movement outside scan area 38 may trigger false alarms. For example, if the monitor apparatus 10 cannot detect a return signal 36 consistent with respiration, the monitor apparatus 10 may incorrectly infer that the infant has stopped breathing, when, in fact, the infant has merely moved outside the scan area 38. It is possible to increase the size of the scan area 38 by generating more energy waves, or by using non-directional energy waves, however, such approaches may increase the overall exposure of the subject to be monitored and/or other living beings in the same general area (such as a room), to the energy waves.

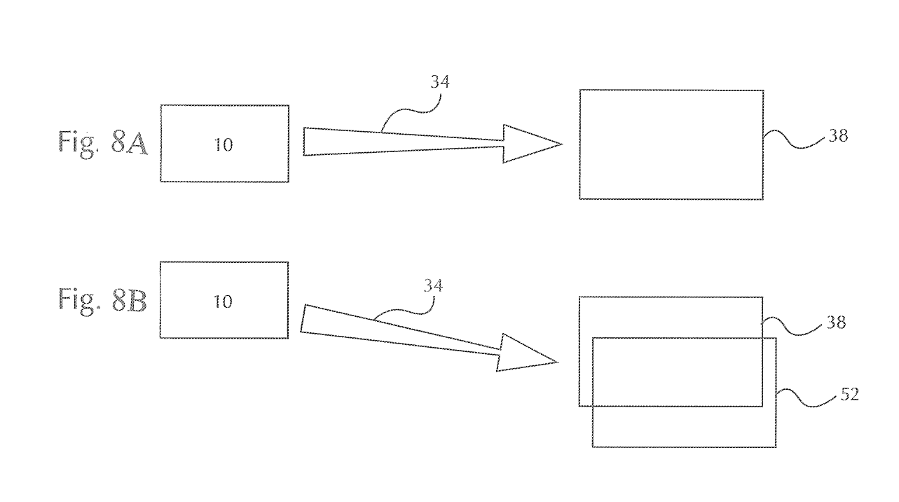

Instead, monitor apparatus 10 may be adapted to expand scan area 38 to adjacent areas, looking for a return signal 36 indicative of the subject, e.g. a return signal 36 consistent with respiration or heartbeat. For example, if monitor apparatus 10 does not receive a return signal 36 consistent with life (e.g., no cyclical movement consistent with respiration or heartbeat), the monitor apparatus 10 as a whole or components of monitor apparatus 10 may move. Such a feature may also facilitate the initial set-up of monitor apparatus 10. That is, monitor apparatus 10 may be self-focusing, such that the user does not need to place the monitor apparatus 10 in a particular position or orientation to ensure that the subject is within the scan area 38. Such a feature may also prevent data loss due to subject movement, or prevent false alarms or other false indications that the subject's condition has changed, when, in fact, only the subject's position has changed. For example, a monitor apparatus 10 may be initially configured to direct outgoing signals 34 at a particular scan area 38, as shown in FIG. 8A. If no return signal consistent with life is received over a specified time period, monitor apparatus 10 may rotate the transmitter, receiver, and/or transceiver to direct outgoing signals 34 at a different scan area 52, as shown in FIG. 8B. In some exemplary configurations, a target, such as an RFID tag, may be used to establish boundaries of the scan area. The boundaries of the scan area may also be established during the initial setup of the monitor apparatus 10.

With continuing reference to FIGS. 8A and 8B, in some exemplary configurations, the user may manually rotate the monitor apparatus 10 to direct outgoing signals 34 at a different scan area 52. The monitor apparatus 10 may be configured to locate a reflecting surface and alert the user when a reflecting surface is found. For example, various locator devices may be used such as a lamp, an LED, sounds, or a display. The locator devices may be integrated in the apparatus or may be separate from it, e.g., the apparatus can transmit respective signal in a wireless way to a locator device,

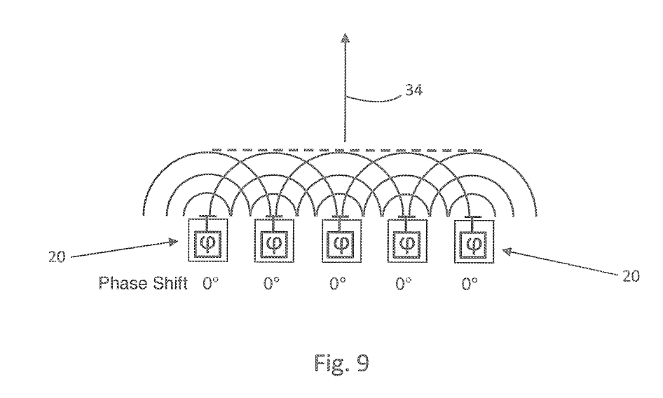

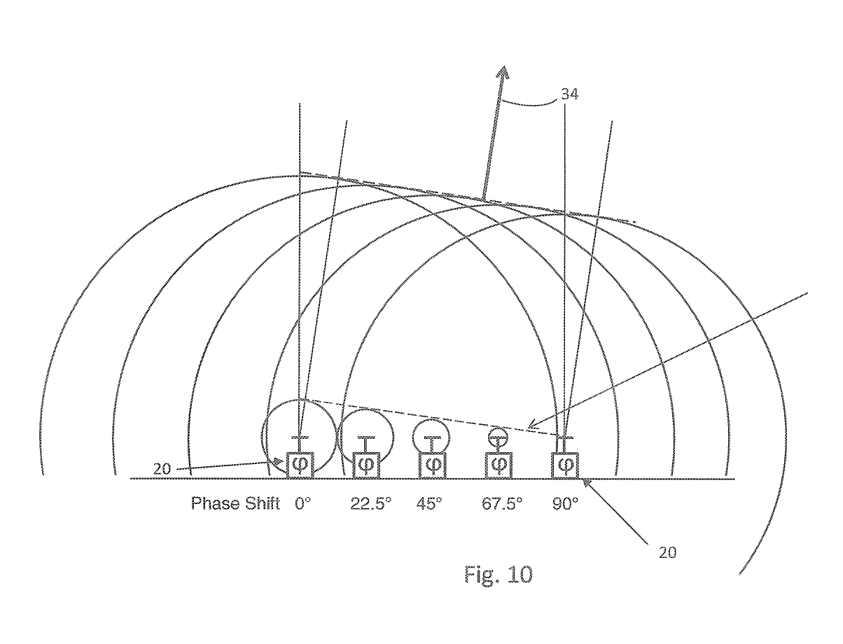

In some exemplary configurations, the monitor apparatus 10 may include an array of antennas 20 for emitting electromagnetic waves as shown in FIG. 9. As shown in FIG. 9, the antennas 20 in the array emit an electromagnetic wave that is perpendicular to the surface of antennas 20 in the array. In such an exemplary configuration, in order direct the outgoing signals 34 to a different scan area 52, the apparatus may be configured to rotate in order to redirect the outgoing signals 34 emitting from the antennas 20. In some exemplary configurations, a slotted wave guide may be rotated to redirect the outgoing signals 34. In some exemplary configurations, a wave director such as, for example, a horn, may redirect the outgoing signals 34 from the array of antennas 20 to a different scan area 52. In another exemplary configuration, the outgoing signals may be redirected by phase shifting the electromagnetic waves emitted from the array of antennas 20 such as shown in FIG. 10. As shown in FIG. 10, by phase shifting the signals emitted from each antenna 20, the array of antennas 20 emits a wave that is not perpendicular to the surface of the array of antennas 20. Referring to FIGS. 9 and 10, it is to be appreciated that when the target is located within the scan area, one or more of the antennas 20 in the array may be turned off in order to reduce the amount of electromagnetic radiation emitted from the monitor apparatus 10. If the monitor apparatus 10 does not receive a return signal consistent with life, the antennas 20 in the array may be turned on until the target is located.

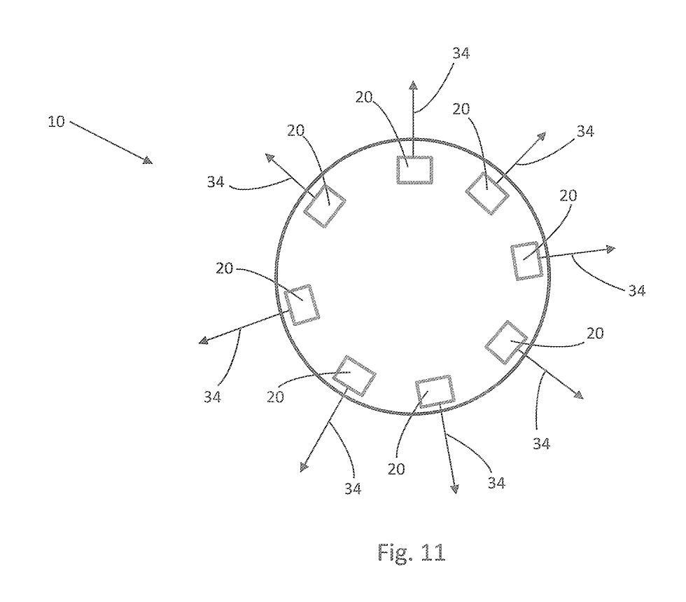

In another exemplary configuration, the apparatus may have a circular shape and an array of antennas may be positioned such that each antenna directs an outgoing signal at a 90 degree angle to the surface of the apparatus as shown in FIG. 11. It is to be appreciated that when the target is located within the scan area, one or more of the antennas 20 in the array may be turned off in order to reduce the amount of electromagnetic radiation emitted from the monitor apparatus 10. If the monitor apparatus 10 does not receive a return signal consistent with life, the antennas 20 in the array may be turned on until the target is located.

In some exemplary configurations, a two-dimensional array of antennas may be used in order change the side-to-side and up-and-down direction at the same time. The apparatus may be configured to adjust the orientation of the arrays of antennas to reposition the scan area to the location of the target.

Movement mechanisms may be configured to provide linear, horizontal and/or vertical movement, or may provide rotational movement. For example, the apparatus may include an internal or external rail system that permits the monitor to move side-to-side. The rail system may include a continuous track so that the entire apparatus, inclusive or exclusive of the rail system, can move along a surface. Alternately, only a portion of the apparatus may move, such as the signal generating components, or the signal receiving components. In some embodiments, a stationary rail or track may be used to move the apparatus or components of the apparatus along a fixed path. In some embodiments, the apparatus or components of the apparatus may be configured to rotate. For example, the apparatus or components of the apparatus may be placed on a platform which can rotate 90°, of 180°, or 360°, or the like, in the general manner of a lazy Susan. Alternately, the apparatus or components of the apparatus may be placed on a vertical or horizontal support that serves as an axis of rotation, allowing the apparatus to rotate partially or entirely in a circle around the support. In some embodiments, the apparatus or apparatus components may follow a helical path along a horizontal or vertical support. The platform and/or the support may be weighted in order to stabilize the monitor apparatus 10.

The apparatus may be used alone or may be incorporated into another object. For example, the monitor apparatus 10 may be incorporated into a toy, bedding, furniture, or the like.

In some embodiments, the apparatus may be a single, integral unit. For example, the signal generating equipment may comprise a transceiver that both generates outgoing (“interrogating”) signals, and receives return signals. The monitor apparatus 10 may be powered in various ways, including, for example using non-rechargeable batteries, rechargeable batteries, capacitors, fuel cells, solar cells, or the like. The monitor apparatus 10 may be powered wirelessly.

The monitor apparatus 10 may comprise a docking station to recharge the device. In some exemplary configurations, the docking station may be in the form of a wall mount that can hold the apparatus and charge the apparatus simultaneously. The wall mount may be configured to adjust vertically and horizontally and may be able to adjust angularly relative to the mounting surface for aligning the scan area with the target.

The monitor apparatus 10 may be placed in various locations. For example, the monitor apparatus 10 may be positioned on a ceiling, wall, furniture (i.e. crib, bed, dresser, desk, and the like), or the like. It is to be appreciated that the power and interference may be reduced by positioning the monitor apparatus 10 relatively near the target area. The monitor apparatus 10 may be positioned so as to limit interference by other objects or subjects.

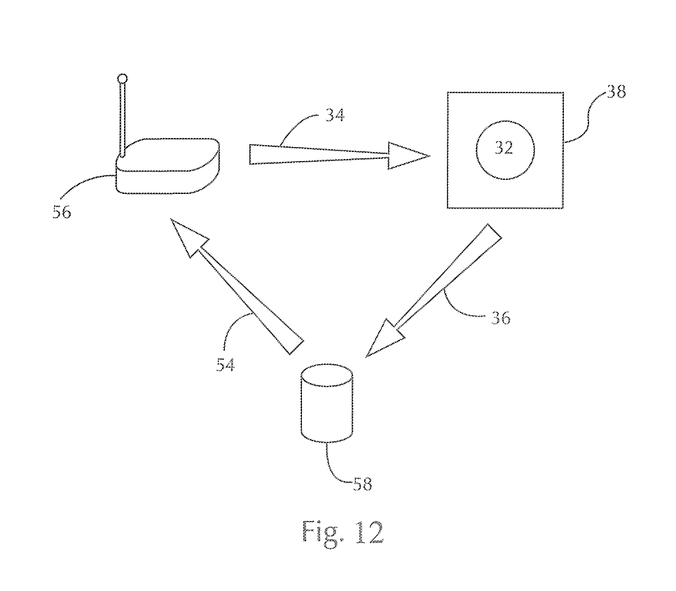

In some embodiments, the transmitter and receiver may be distinct, or two separate transceivers may be used. In some embodiments, the transmitter and receiver may be physically separate, or physically separable. For example, as shown in FIG. 12, the monitor apparatus 10 may comprise a base 56. The base 56 may have a transmitter for generating outgoing signals 34. The monitor apparatus 10 may comprise a receiving unit 58. The receiving unit 58 may be a portable unit, separate or separable from the base 56. The base 56 may generate outgoing signals 34, and the receiving unit may detect return signals 36. The receiving unit 58 may further comprise a transmitter. The receiving unit 58 may be moved closer to the target, relative to base 56, so that any losses in return signal strength is minimized, and, therefore, the strength of the interrogating signal from base 56 to target 32 can be reduced. The receiving unit 58 may amplify and repeat the return signals 36, relaying them back to the base 56 as relay signals 54. A directional relay signal may be used to reduce the additional electromagnetic energy exposure to the subject from the receiving unit's transmissions to the base. In some embodiments, the receiving unit may have a wireless connection to the base.

In some embodiments, the receiving unit 58 may have a physical connection to the base 56. Of course, wires may extend between the receiving unit 58 and the base 56, such that signals or data can be transferred from the receiving unit 58 to the base 56. However, in some environments, a wired connection may be undesirable. For example, in a nursery or crib, wires may pose a strangulation hazard. The strangulation hazard may exist even if the wires are not placed directly in the crib, but are within arm's reach of an infant or child in the crib, or are accessible when the infant or child is not in the crib. In some embodiments, the physical connection may exist through a docking station. The receiving unit 58 may include a memory. The receiving unit 58 may be placed in closer physical proximity to the target 32 during monitoring, relative to the base 56. When monitoring session is complete, the receiving unit 58 may be connected to the base 58 via the docking station. In some embodiments, the docking station may allow the receiving unit 58 to physically nest in or adjacent to the base 58. In some embodiments, the docking station may be a port, such as a USB port, that permits the connection of the receiving unit 58 to the base 56. The receiving unit 58 and/or the base 56 may have a built in connection, such as a built-in cord or hub, or a separate cord or hub may be used to connect the receiving unit 58 to the base 56. In some embodiments, the docking station both transfers data from the receiving station 58 to the base 56 and recharges the receiving station 58.

In some embodiments, the receiving station 58 does not communicate directly with the base 56. For example, the receiving station 58 may collect data for later transfer to a computer, mobile computing device (e.g., a smart phone) or other data-handling equipment. As a specific, non-limiting example, the memory of the receiving station 58 may be in the form of a flash or thumb drive that can be removed from the receiving station 58 to transfer data to another device, such as the base 56, a computer, or a mobile computing device.

As shown in FIG. 6, outgoing signals 34 and return signals 36 attenuate at a rate inversely proportional to distance 40. As distance 40 is increased, the receiver for detecting return signals 36 must be made more sensitive to detect the more attenuated return signals 36, if all other factors are held constant. As some point, the receiver would require such heightened sensitivity that it would overwhelmed by spurious signals in the environment. With a receiving station 58 placed in close proximity to the target 32, the total distance (outbound and return) that the signals travel prior to detection of return signals 36 is reduced. Thus, the use of a receiving station 58 may permit the use of lower power outgoing signals 34. If the receiving station 58 does not transmit energy waves, or uses directional energy waves oriented away from target 32 to communicate with base 56, the use of a receiving station 58 may reduce the total signal power to which target 32 is exposed during monitoring. The use of a receiving station 58 may also permit greater flexibility in setting up monitor apparatus 10 in a non-standard environment. For example, if it is desired to place base 56 near outlets, for example, electrical or network connections, receiving station 58 may permit the placement of base 56 a greater distance 40 from target 32 than would otherwise be possible at a similar outgoing signal 34 power. Providing two or more separate or separable parts of monitor apparatus 10 may also permit the development of use-specific components. For example, if monitor apparatus 10 is intended for use as a baby monitor, receiving unit 58 could be configured to present no wires or small or protruding pieces which could present safety hazards to infants. In some embodiments, receiving unit 58 could be adapted aesthetically or functionally for its intended use. For example, if monitor apparatus 10 is intended for use as a baby monitor, receiving unit 58 could be configured to snap onto standard-size crib rails so that no free-standing support (such as a changing table or dresser) is required for receiving unit 58. As another example, if monitor apparatus 10 is intended for use in home health care or with shared exercise equipment or in other uses where it may be necessary or desirable to thoroughly clean the portions of monitor apparatus 10 in closest proximity to target 32, receiving unit 58 may be configured such that at least the outside of the unit is readily sanitized or even sterilized.

Whether provided as one, inseparable unit or as separate or separable parts, monitor apparatus 10 may be adapted to provide continuous or intermittent monitoring. For example, as discussed above, continuous monitoring may involve non-stop generation of outgoing signals 34 during the time the monitor apparatus 10 is in operational mode (e.g., turned on and monitoring, as opposed to when turned off, or when in a set-up mode). Intermittent monitoring may involve periods of outgoing signal generation interrupted by periods of no outgoing signal generation during the time the monitor apparatus 10 is in operational mode. Intermittent monitoring will expose the target 32 to less cumulative energy wave exposure than continuous monitoring, when monitoring time and other conditions are held constant.

Due to differences in physiology, it may be possible to manipulate intermittent monitoring to further reduce total energy wave exposure from the monitor based upon the condition and target to be monitored. For example, different periods of intermittent monitoring are needed to measure breathing in humans of different ages. Infants, 0-1 year of age, typically have respiration rates from 30 to 60 breaths per minute. Toddlers, from 1 to 3 years of age, typically have respiration rates from 24 to 40 breaths per minute. Adolescent or adults typically have respiration rates from 12 to 16 breaths per minute. To measure breathing for an infant, the measurement time (e.g., the time the apparatus is actively producing outgoing signals 34) could be reduced to ⅕ to ½ of the time required to measure breathing for an Adolescent or Adult. Thus, manipulation of intermittent monitoring can reduce the time the infant or toddler is exposed to electromagnetic or other signal waves by 50-80%. Infants, 0-1 year of age, typically have heart rates of from 90 to 160 beats per minute. Toddlers, from 1 to 3 years of age, typically have heart rates from 80 to 150 beats per minute. Adolescent or adults typically have heart rates from 55 to 100 beats per minute. To measure heart rate for an infant, the measurement time could be reduced to ⅓ to ½ of the time required to measure heart rate for an Adolescent or Adult. Thus, manipulation of intermittent monitoring can reduce the time the infant or toddler is exposed to electromagnetic or other signal waves by 50-67%. Monitor apparatus 10 may be adapted for a specific age group and purpose. Alternatively, monitor apparatus 10 may accept as an input the age of the target and/or the physiological condition to be monitored and adjust the timing of generation of outgoing signals 34 accordingly. Similar input interfaces to those described above for distance input could be used for age and/or physiological condition to be monitored.

An additional approach to reducing the power of outgoing signals 34 is to change the reflectivity of the target 32. One way to change the reflectivity of target 32 is through clothing. Sleepwear, exercise, career or casual wear may include conductive fibers. Such clothing may increase the reflectivity of target 32 at the surface (i.e., where the clothes lie), and may also reduce energy delivery to or below the surface of the subject (i.e., to tissues below the skin surface). Fabrics comprising conductive fibers are commercially available from, for example, King's Metal Fiber Technologies Co., Ltd., of Taipei, Taiwan; and Less EMF Inc. of Albany, N.Y. Exemplary conductive fibers may include aluminum, copper, nickel, silver, gold, continuous paths of carbon, or combinations thereof.

To manage the cost of reflective clothing, it may be possible to adjust the spacing between conductive fibers based on the frequencies to be used or likely to be used in contactless monitoring. Smaller distances between conductive fibers will reflect higher frequencies. A cross-hatch patter of conductive fibers will be more reflective than all vertical or all horizontal strands of conductive fibers in a fabric. The conductive fibers may be used throughout an article of clothing, or only at specific points of interest. For example, conductive fibers may be present in the region of a garment that will cover the rib cage, or a portion of the rib cage, to emphasize chest movement from breathing. Alternately, the target 32 may be highlighted by using textiles comprising resistive fibers. Resistive fibers may absorb more electromagnetic or other energy signals. Thus, the use of resistive fibers in, for example, bedding, may help isolate the return signals 36 from the target 32. This may facilitate signal processing for relatively lower power return signals 36. One exemplary resistive fabric comprises cotton with large amounts of carbon in discontinuous paths. Resistive fibers or fabrics absorb and dissipate the energy signals as heat. The quantity of heat produced would typically be minimal, possibly measurable but insufficient to provide meaningful warmth or to cause discomfort. Bedding with resistive fibers may include linens such as mattress covers, fitted sheets, pillow covers, or the like. Bedding with resistive fibers may exclude blankets or flat sheets, as covering the target with a blanket or flat sheet adapted to absorb and dissipate energy waves may make it more difficult to monitor the target. Of course, blankets, flat sheets, or other bedding or linens which could cover the target could be adapted to include conductive fibers to help emphasize movements of the target under the covers.

In some embodiments, an article of clothing may have regions comprising conductive fibers and regions comprising resistive fibers. As used herein, a “region” is an area encompassing a circle at least 1″ (2.54 cm) in diameter when the “region” of the clothing is laid flat (it may be necessary to snip elastics or other trim to cause the region of interest to lie flat). For example, an article of clothing may have one or more regions comprising conductive fibers. The regions comprising conductive fibers may correspond, when worn, to one or more of the wearer's heart, lungs, joints, or pulse points. An article of clothing may have one or more regions comprising resistive fibers. The regions comprising resistive fibers may correspond, when worn, to one or more of the wearer's heart, lungs, joints, or pulse points. As one specific example, a region comprising conductive fibers may correspond to the wearer's heart, and a region comprising resistive fibers may correspond to the wearer's lungs, such that return signals 36 are intensified from the wearer's heart and attenuated from the wearer's lungs. As another non-limiting example, a region comprising resistive fibers may correspond to the wearer's arms or legs, to attenuate return signals 36 which may indicate voluntary movement, or involuntary movement not directly associated with breathing or heart beat. In other embodiments, regions of resistive and conductive fibers may be used to intensify return signals associated with voluntary movements rather than involuntary movements.

Fabrics containing conductive fibers and fabrics containing resistive fibers may be used together. For example, bedding sets may comprise a fitted sheet with resistive fibers and a flat sheet with conductive fibers. A kit for enhancing the contactless monitoring of a living subject may comprise a fitted sheet with resistive fibers and a flat sheet with conductive fibers. Instead of or in addition to flat or fitted sheets, the kit may comprise clothing comprising conductive fibers. The clothing may comprise conductive fibers in only a portion of the garment, such as the portion of the garment corresponding to the rib cage of a wearer when worn. The clothing may be in the form of a shirt, a nightshirt, a bodysuit, a unitard, pajamas, a nightgown, a sleep sack, a sports bra, athletic apparel, leggings, tights, pants, a skirt, or the like. Instead of or in addition to clothing, a band or strip of fabric comprising conductive fibers may be configured (e.g., sized, shaped) to fit around the rib cage of a wearer, or around the neck of a wearer, or around the arm, leg, abdomen, or other locations. The band or strip may be configured to fit at or near a pulse point, a point where an artery is sufficiently near the surface of the body that movement of the artery may be detected by contactless monitoring. The kit may comprise further elements, such as pillowcases, blankets (inclusive of bedspreads, coverlets, quilts, and the like), draperies, curtains, wall hangings, and combinations thereof, each comprising conductive and/or resistive fibers.

Proposed safety guidelines for exposure to non-ionizing radiation include thresholds for power density, electric field strength, and Electromagnetic Field (EMF) exposure. Under some hypotheses, EMF exposure is particularly relevant with respect to Ultra High Frequency (UHF, 300 MHz to 3 GHz) and Super High Frequency (SHF, 3 GHz to 30 GHz) radio frequencies. Each of these measures can be calculated to provide a reasonable approximation of the exposure generated by an apparatus as described herein, based on the power of the outgoing signals 34 and the distance 40 from monitor apparatus 10 (base 56, if used) to the target 32. Watts are the units used to describe the amount of power generated by a transmitter. Microvolts per meter (μV/m) are the units used to describe the strength of an electric field created by the operation of a transmitter. A particular transmitter that generates a constant level of power (Watts) can produce electric fields of different strengths (μV/m) depending on, among other things, the type of transmission line and antenna connected to it. Because it is the electric field that causes interference to authorized radio communications, and because a particular electric field strength does not directly correspond to a particular level of transmitter power, the emission limits of, for example, short range devices and broadcasting transmitters, are specified by field strength.

Although the precise relationship between power and field strength can depend on a number of additional factors, the relationship can be approximated based on the following formula:

$$\frac{PG}{4 {d}^{2}} = \frac{{E}^{2}}{120 Ω}$$

where P is transmitter power in Watts, G is the numerical gain of the transmitting antennae relative to an isotropic source, d is the distance of the measuring point from the electrical center of the antenna in meters, and E is the field strength in Volts/meter. As to the denominators, 4πd² is the surface area of the sphere centered at the radiating source whose surface is d meters from the radiating source, and 120π is the characteristic impedance of free space in Ohms. Using this equation, and assuming a unity gain antenna (G=1) and a measurement distance of 3 meters (d=3 m), a formula for determining power given field strength can be developed:

$$P = 0.3 \frac{{m}^{2}}{Ω} {E}^{2}$$

where P is the transmitter power (EIRP) in Watts and E is the field strength in Volts/meter. The following expression relates power flux-density in dB(W/m²) with field strength in dB(μV/m):

E=S+145.8

where E is field strength in dB(μV/m) and S is power flux-density in dB(W/m²).

As discussed above, the maximum safe level of exposure is a matter of ongoing investigation. Extremely high exposure to electromagnetic radiation is known to cause heating, and the thermal effects in turn can influence biological tissues in undesirable ways. However, it is unclear whether exposures unassociated with thermal effects are themselves harmful, and if so, at what levels.

Based on the information available today, for continuous monitoring, it may be desirable to limit the average maximum power density at the target 32 to less than 10 mW/cm² (milliwatts per square centimeter). This limit is based on studies on healthy adult humans, and so different limits may be desirable for infants, children, or non-human subject. Thus, particularly, but not exclusively, where a contactless monitor may be used continuously in a mixed household of inhabitants of varying sensitivities, it may be desirable to limit the average maximum power density at the target 32 to no more than 500 μW/cm² (microwatts per square centimeter), or no more than 50 μW/cm², or even no more than 20 μW/cm². It may be desirable to limit the average maximum energy density at the target 32 to no more than 1 mW hr/cm² (milliwatt-hour per square centimeter) for interrupted or modulated electromagnetic radiation. Each of these averages is taken over any possible six minute (0.1 hour) period.

For continuous monitoring, it may be desirable to limit the equivalent free space average electric field strength at the target 32 to no more than 200 V²/m² (volts-squared per meter-squared), or, for interrupted or modulated electromagnetic exposure, to limit the mean squared electric field strength to no more than 4×10⁴V²/M². For continuous monitoring, it may be desirable to limit the equivalent free space average magnetic field strength to no more than 0.5 A/M (amperes per meter), or, for interrupted or modulated electromagnetic exposure, to limit the mean squared magnetic field strength to no more than 0.25 A²/m² (amperes squared per meter squared). Each of these averages is taken over any possible six minute (0.1 hour) period. It may be desirable to limit the EMF level at the target 32 to no more than 10 mG (milliGauss), or no more than 3 mG, or no more than 1 mG, or even no more than 0.5 mG.

In some embodiments, an apparatus as described herein may modify the power level of outgoing signals 34 to keep the calculated power density, electric field strength, and/or electromagnetic field at the target 32 below a maximum safety threshold level. Of course, there may be many sources of electromagnetic radiation in the environment that are unrelated to a contactless monitor. Thus, in some embodiments, an apparatus as described herein may detect the power density, electric field strength, and/or electromagnetic field at target 32 and compensate for other energy sources. For example, set-up target 42 may include meters for power density, electric field strength, and/or electromagnetic field, or monitor apparatus 10 may request entry of measured power density, electric field strength, and/or electromagnetic field values at target 32 during a set-up phase, similar to a request for a distance measurement as described above. Monitor apparatus 10 may then adjust so as not to add energy to the environment to bring the measured power density, electric field strength, and/or electromagnetic field above the maximum safety threshold. Given the ambiguity around the “correct” maximum safety threshold, monitor apparatus 10 may include an option to input a maximum safety threshold or to override the maximum safety threshold. If monitor apparatus 10 connects to the internet or a mobile computing network, monitor apparatus 10 may be configured so that it can be reprogrammed or updated periodically to reflect current best practices with regard to maximum safety thresholds for electromagnetic radiation exposure, as those practices evolve over time. In some embodiments, during transmission of data via a mobile network, monitor apparatus 10 may stop transmitting interrogating signal 34, or, in the case of an intermittent interrogating signal 34, monitor apparatus 10 may transmit data over a wireless network between interrogation cycles.

The living subject or target 32 to be monitored may be any human, including adults, infants, toddlers, children, adolescents, young adults, or elderly persons. In some instances, the living subject or target 32 may be a non-human animal, such as a farm animal; working animal; domestic or companion animal; or even a feral animal; such as a wild animal in captivity, such as at zoos or aquariums, or in transit for relocation, or in rehabilitation after injury. The condition to be monitored may be fundamental physiology, such as pulse, respiratory (breathing) rate, movement, or the like, or may be a higher-order inference. Fundamental physiology may be inferred from return signals 36, as described above. Higher-order inferences may be further inferred from fundamental physiological inferences, and may include monitoring of conditions such as sleep, sleep state (e.g., “depth” of sleep, dreaming or non-dreaming, etc.), wakefulness, drowsiness, physical exertion (such as exercise), presence or absence of the subject in the scan area, mobility, emotional state (such as fearful or relaxed), health, and the like, or combinations thereof.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An apparatus for contactlessly monitoring the condition of a living subject, the apparatus comprising:
an electromagnetic wave generator, the electromagnetic wave generator being capable of producing electromagnetic waves of varying power, amplitude, duty cycle, and frequency;
a processor adapted to detect changes in an electromagnetic wave generated by the electromagnetic wave generator over time; and
a measurement device adapted to determine a distance between the apparatus and a target;
wherein at least one of the power, amplitude, duty cycle, or frequency of the electromagnetic waves generated by the electromagnetic wave generator is modified based on the distance between the apparatus and the target.

2. The apparatus of claim 1, wherein the power, amplitude, duty cycle, or frequency of the electromagnetic waves generated by the wave generator is modified automatically.

3. The apparatus of claim 1, wherein the power, amplitude, duty cycle, or frequency of the electromagnetic waves generated by the wave generator is modified internally.

4. The apparatus of claim 1, wherein at least one of power or frequency of the electromagnetic wave as generated is adjustable until the power of the return signal is below a maximum safety threshold.

5. The apparatus of claim 1, wherein the living subject is a child from zero to three years of age.

6. The apparatus of claim 1, wherein the power and frequency of the waves generated by the electromagnetic wave generator are both modified.

7. The apparatus of claim 1, wherein the measurement device comprises a range finder.

8. The apparatus of claim 1, wherein the range finder comprises an RFID tag.

9. The apparatus of claim 1, wherein the electromagnetic wave as generated has a wavelength and/or frequency selected from the group consisting of radio frequency, microwave, x-ray, and terahertz.

10. The apparatus of claim 1, wherein the electromagnetic wave generator intermittently produces electromagnetic waves.

11. The apparatus of claim 1, wherein the electromagnetic wave generator continuously produces electromagnetic waves for a period followed by a period of inactivity.

12. The apparatus of claim 1, wherein the electromagnetic wave generator intermittently produces electromagnetic waves for a period followed by a period of inactivity.

13. The apparatus of claim 1, wherein the apparatus is mounted to a crib, wherein the apparatus is wirelessly powered.

14. The apparatus of claim 1, wherein the apparatus is mounted to a ceiling.

15. An apparatus for contactlessly monitoring the condition of a living subject, the apparatus comprising:
an electromagnetic wave generator, the electromagnetic wave generator being capable of producing electromagnetic waves of varying power, amplitude, frequency, duty cycle, or output direction, wherein the electromagnetic waves are directed at a target in a scan area;
an electromagnetic wave receiver, the electromagnetic wave receiver being capable of receiving electromagnetic waves generated by the electromagnetic wave generator;
a processor adapted to detect changes in an electromagnetic wave received by the electromagnetic wave receiver over time,
wherein the output direction of the electromagnetic waves is modified based upon a change in an electromagnetic wave detected by the processor.

16. The apparatus of claim 15, wherein the electromagnetic wave generator comprises a directional antenna, wherein the directional antenna is configured to rotate in order to locate the target in a second target area.

17. The apparatus of claim 15, wherein the electromagnetic wave generator comprises a plurality of antennas, wherein the plurality of antennas are configured to phase shift the generated electromagnetic waves.

18. A method for adjusting an apparatus for monitoring the condition of a living subject, the method comprising:
providing an apparatus, the apparatus comprising an electromagnetic wave generator capable of producing waves of varying power, frequency, or both; and a processor adapted to detect changes in a wave generated by the wave generator over time;
measuring a distance and/or direction between the apparatus and a target; and
adjusting at least one of the power or frequency of the waves produced by the wave generator based on the distance and/or direction between the apparatus and the target.

19. The method of claim 18, wherein the distance is measured using the waves generated by the wave generator.

20. The method of claim 18, wherein measuring a distance and/or direction between the apparatus and a target comprises measuring the distance and/or direction with a measurement device, wherein the measuring device is independent of the apparatus, and the measurement is input into the apparatus, wherein the measurement is input into the apparatus via a structure selected from the group consisting of a keyboard, a wireless data communication, a wired data communication, a wireless network connection, a wired network connection, a switch, a dial, a touch pad, by sound, by optical signs, and a voice recognition system.
